(19) United States
(12) Patent Application Publication
(10) Pub. No.: US 2009/0288027 A1
(43) Pub. Date: Nov. 19, 2009

(54) VISUALIZATION AND MANAGEMENT OF INFORMATION TECHNOLOGY COMPONENTS

(75) Inventor: Senthil Prabakaran, Portland, ME (US)

Correspondence Address: PATRICK R. SCANLON;PRETI FLAHERTY BELIVEAU & PACHIOS LLP, ONE CITY CENTER, PORTLAND, ME, 04112-9546, US

(73) Assignee: DWITA, INC., Portland, ME (US)

(21) Appl. No.: 12/122,485

(22) Filed: May 16, 2008

(51) Int. Cl. G06F 3/048

(52) U.S. Cl. 715/769; 715/771

(57) ABSTRACT

Computer systems, methods and software are provided for visualizing and managing information technology components associated with a computer system. This can include displaying a grid having a plurality of cells, wherein each cell is capable of containing a unit of management and receiving user input associating a unit of management with a one of the cells. The unit of management is then displayed in the cell in response to this user input.

### CROSS REFERENCES TO RELATED APPLICATIONS

This application claims the benefit of U.S. Provisional Application No. 60/930,631, filed May 17, 2007.

### BACKGROUND OF THE INVENTION

This invention relates generally to visualizing hardware, software and network systems and their relationships and specifically for managing them using a spreadsheet-like interface.

For large organizations, various computer systems include hardware, software and networking connected and related in many ways. For example, an email system can comprise email server software that runs on a computer server. This email server software connects to directory service software that runs on another computer operating as a server. Users of the email system connect to the email server from their workstations. Managing such a simple system is complicated because of the different interconnections and dependencies.

Apart from all the interconnections, the granularity of the different components may not be clear. To break down complex software into its components and finding dependencies among different components is a challenge.

Managing software systems encompasses different functions that includes deployment of software to different computers, monitoring and diagnosing software issues, automating management of configuration through the use of policies and scripts, documenting the configuration, delegating the security and identity of the software and managing disaster-recovery of the software system.

Current methods to visualize computer software, hardware or network systems include diagramming software programs. These diagramming tools are oriented towards visualizing and printing on paper. Hence, they are limited in size and cannot model numerous objects that can exist in a real world computer network.

### SUMMARY OF THE INVENTION

In one embodiment, the present invention provides a computer system including a display, a means for discovering software, hardware or network components, a means for adding the discovered components as ‘units of management’ to a spreadsheet-like hexagonal grid, and a means for managing different aspects of the unit of management. A database is included for storing information about the units of management. The computer system includes a processor that is responsive to instructions to discover components on the network. The computer system is also responsive to user input to add and manage units of management to the hexagonal grid and causes the display to show the updated hexagonal grid.

In another embodiment, the present invention provides a method of using a computer system to discover, add and manage units of management using a hexagonal grid. Each cell in the hexagonal grid can contain a unit of management. The hexagonal cell can display performance indicators, issues, icon, name, popular configuration settings and other information relating to the unit of management. Each unit of management can be visually linked to other units of management to indicate their relationships. The display of the hexagonal cell can change depending on the relationships set up.

In yet another embodiment, the present invention provides a computer readable medium containing instructions for controlling a computer system to perform the method of providing, discovering, adding and managing units of management using a hexagonal grid as discussed above.

### DESCRIPTION OF THE DRAWINGS

FIG. 1 is a block diagram of a computer system capable of implementing a software application for visualizing and managing information technology components associated with the computer system.

FIG. 2 shows a representation of a user interface screen that is caused to be displayed by the software application.

FIG. 3 shows the user interface screen with two units of management having performance monitoring graphs

FIG. 4 shows the user interface screen showing a menu for performing management operations on a unit of management.

FIG. 5 shows the user interface screen showing the status of a unit of management.

### DETAILED DESCRIPTION OF THE INVENTION

The present invention relates generally to a software application for visualizing and managing information technology components associated with a computer system. As used herein, the term “information technology component” refers to software, hardware and/or network components, including, but not limited to, include tangible components like servers, databases, network routers, users, groups, computers, etc., as well as intangible components including, for example, IT service levels, cost objectives, performance metrics, IT objectives, business processes, project information, documents, and other logical entities. The term “computer system” refers to any type of device that is capable of processing data based on a list of instructions. This includes, but is not limited to, server computers, desktop computers, laptops, personal digital assistants (PDAs), wireless e-mail devices, video game systems and the like.

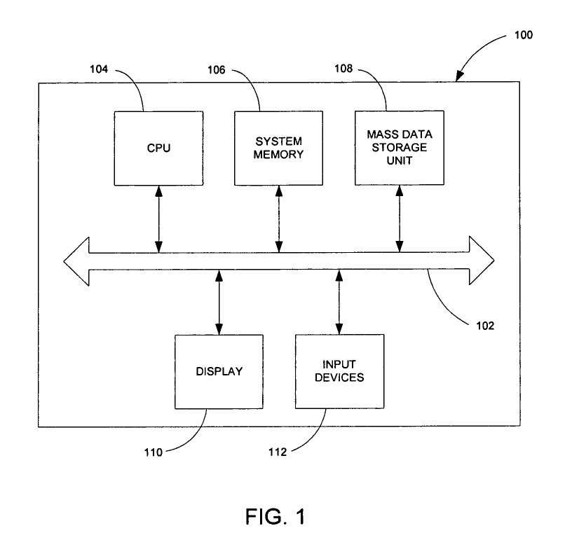

The software application can be implemented on any suitable computer system associated with one or more information technology components. FIG. 1 depicts one possible embodiment of a computer system 100 that can be used to implement the software application. In general, the computer system 100 includes a system bus 102 for communicating information and a central processing unit (CPU) 104 for processing information and instructions. The CPU 104 is coupled with the bus 102 and may comprise one or more processors or microprocessors. The computer system 100 also includes a system memory 106 and a mass data storage unit 108 coupled with the bus 102. The system memory 106 generally includes computer readable media for storing information and instructions for the CPU 104. This can be in the form of volatile memory such as random access memory (RAM) and/or non-volatile memory such as read only memory (ROM). The mass data storage unit 108 may include one or more types of removable and/or non-removable computer readable media. These include, but are not limited to, a hard disk, a floppy disk, an optical disk such as a CD-ROM, CD-R, CD-RW, DVD-ROM, DVD-RAM or other optical media, and flash memory. Also coupled to the bus 102 is a display 110 for displaying information to a user and one or more input devices 112 for allowing users to enter commands and/or information to the computer system 100.

In one possible implementation, the software application resides within one or more computer readable media of the computer system 100. For instance, the software application can be downloaded onto the system memory 106 and/or the mass data storage unit 108 of the computer system 100. Alternatively, the software application could be accessed from a removable computer readable medium (such as a floppy disk, CD-ROM or the like) inserted into the appropriate drive of the computer system 100. In another possible implementation, the software application could reside on a remote computer readable medium and be accessed by the computer system 100 via the Internet or other computer network. As used herein, the term “computer readable medium” refers generally to any medium (including both volatile and non-volatile media, as well as removable and non-removable media) from which stored data can be read by a computer or similar device. Computer readable media include, but are not limited to, hard disks, floppy disks, magnetic cassettes, flash memory cards, flash drives, optical media such as a CD-ROM, CD-R, CD-RW, DVD-ROM, DVD-RAM and the like, random access memories (RAMs), read only memories (ROMs), and other integrated circuit memory devices. While one exemplary computer system has been described for purposes of illustration, it should be noted that the present invention is not limited to implementation on this particular system. Many other systems are possible.

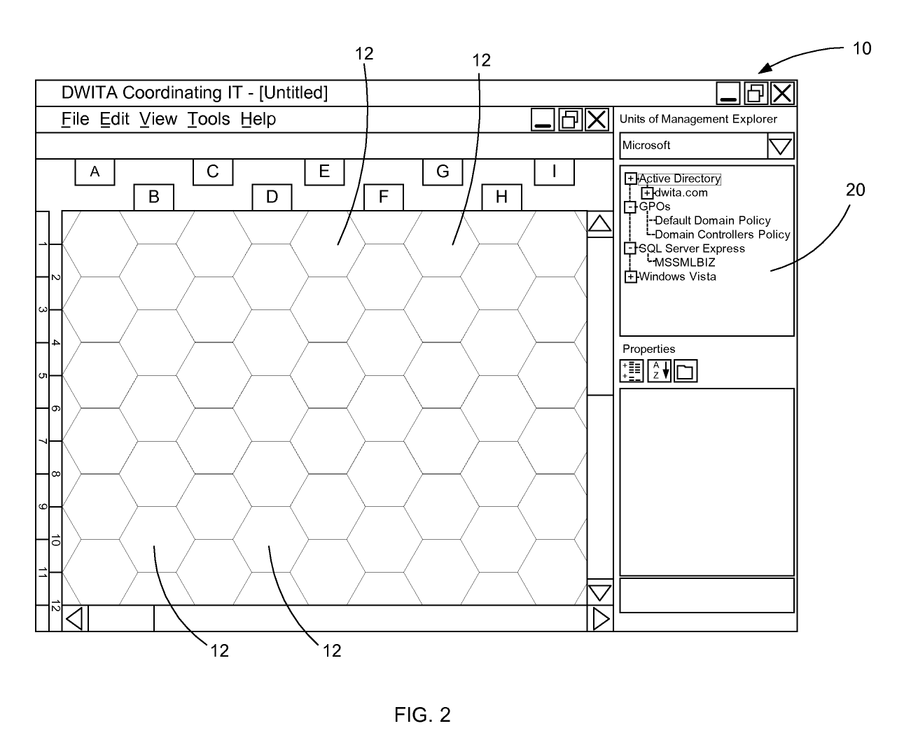

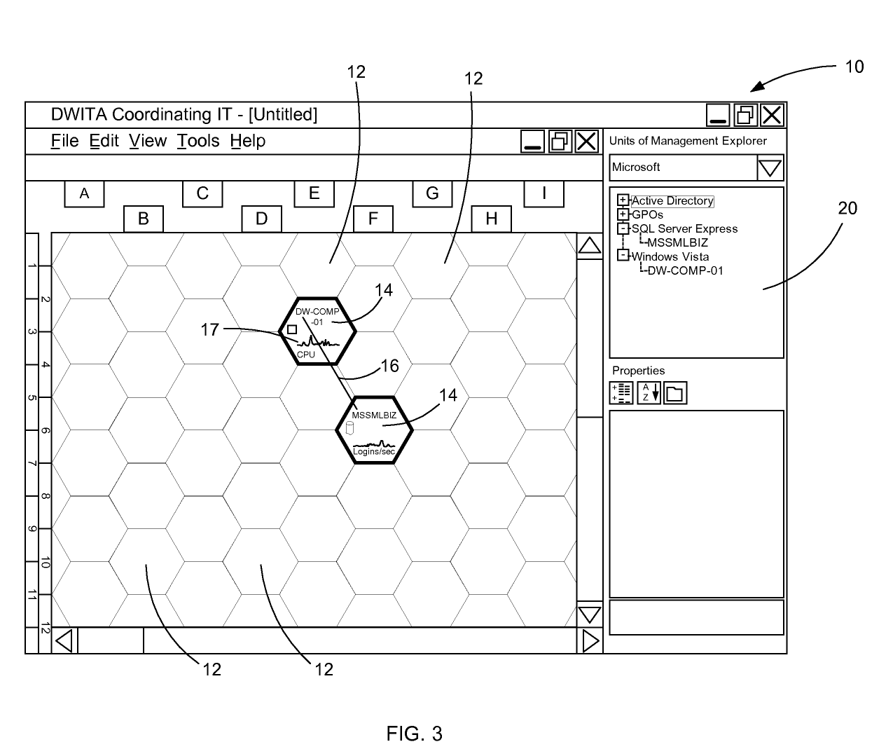

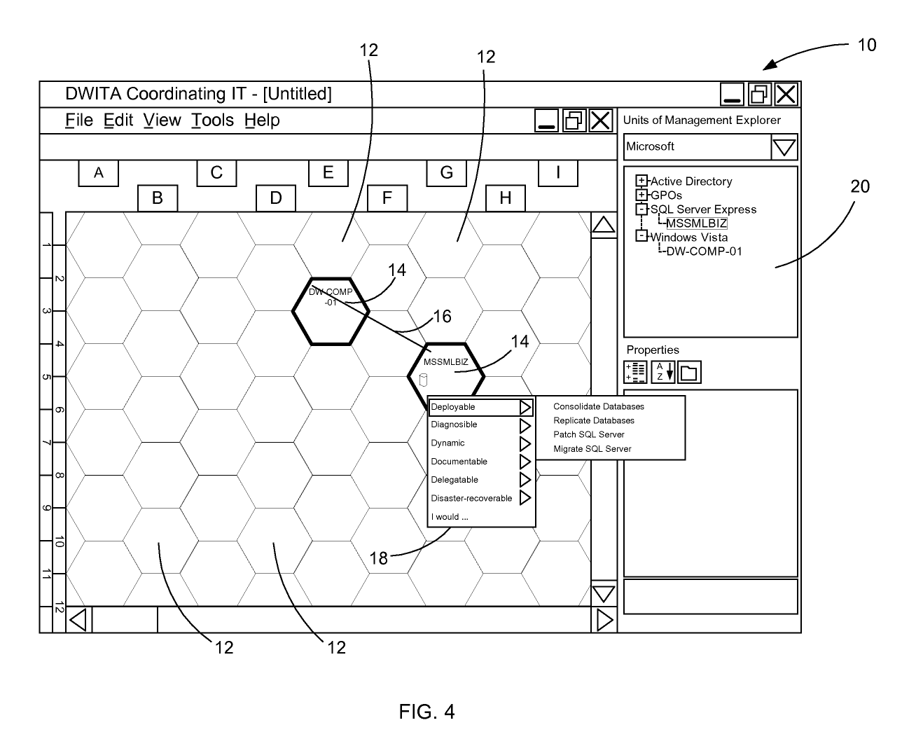

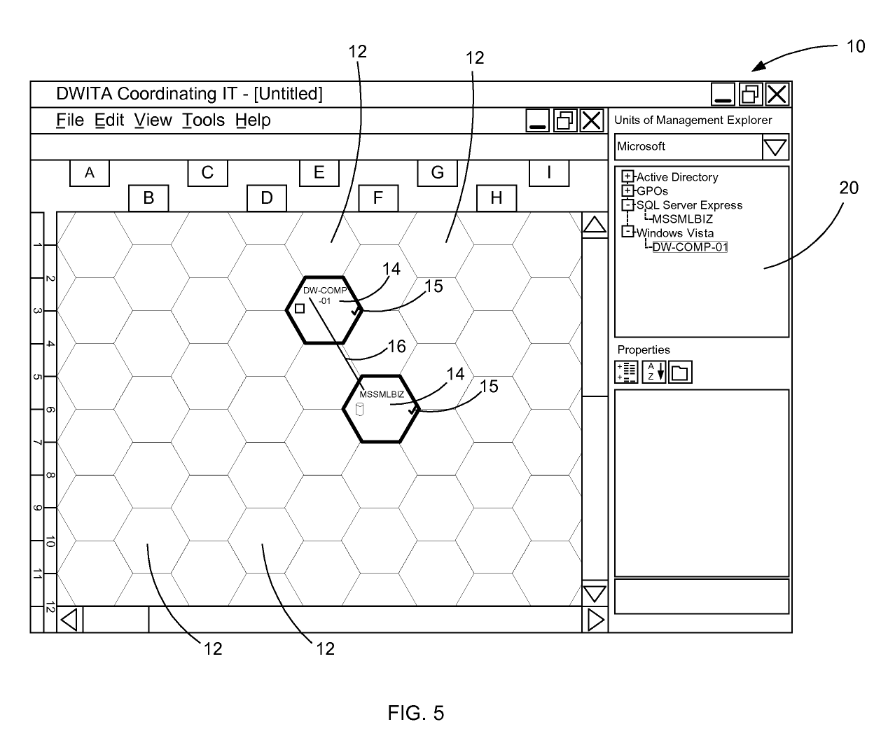

FIGS. 2-5 depict one embodiment of a user interface screen that is caused to be shown on the display 110 by the software application. The user interface screen includes a grid 10 that is a spreadsheet-like structure having a plurality of hexagonal cells 12 that are identified by rows and columns. In one embodiment, the rows are numbered, whereas the columns have alphabetical designation (A to Z, AA to AZ, BA to BZ, etc.). The maximum number of rows and columns is 1 million, but theoretically, there is no limit. The grid 10 can be zoomed in or zoomed out to view less or more of the grid 10. The grid 10 can be printed using a printer.

Each cell 12 can contain a unit of management 14. A unit of management 14 is a representation of an information technology component that needs to be managed. This can include tangible components like servers, databases, network routers, users, groups, computers, etc., as well as intangible components including, for example, IT service levels, cost objectives, performance metrics, IT objectives, business processes, project information, documents, and other logical entities.

Units of management 14 can also have configuration settings. These settings represent the parameters of the unit of management 14. For example, in a database server, a configuration setting specifies the maximum amount of memory the database service can use.

The units of management 14 can be linked together to depict a relationship between the units of management. A link, which can be represented by a line 16 extending between the units of management and optionally a label and icon depicting the type of relationship, can be displayed on the grid 10. Adjacent cells 12 do not have any explicit relationships defined by the grid 10. However, related objects can be modeled closer to each other.

Each cell 12 in the grid 10 containing a unit of management can display different information about the units of management 14 such as a name for the unit of management, an icon representing the type of the unit of management 14, an icon 15 representing the health status of the unit of management 14, performance graphs 17 in the form of spark lines, metrics associated with the unit of management 14, selected configuration settings of the unit of management 14, status of automated operations for the unit of management, etc. Information from other systems can be displayed in the cell 12. For example, health status monitored by other monitoring solutions can be displayed in the cell 12.

Each cell 12 can also have a context sensitive menu 18 that can be used to perform operations on the unit of management 14. Selecting an operation from the menu 18 launches a wizard or other user interface elements to get relevant parameters from the user and perform the operation.

The user interface screen further includes a unit of management explorer 20 that is typically displayed adjacent to the grid 10. The unit of management explorer 20 provides the user with a list of units of management 14 corresponding to the information technology components associated with the computer system 100. The list can be formulated using discovery methods specific to the component being discovered. For example, to list SQL Server databases in the network, application programming interfaces (APIs) specific to SQL Server is used to display the list of database units of management 14.

Alternatively, for intangible units of management 14, the unit of management explorer 20 is a repository of such objects. The intangible units of management 14 can be managed in the unit of management explorer 20. For example, a service level unit of management 14 can be created in the unit of management explorer 20. The units of management 14 in the unit of management explorer 20 can be categorized using different schemes. When modeling changes, virtual tangible objects can be created in the unit of management explorer 20, which can be used in the grid 10.

The user interface screen allows users to visualize the information technology components associated with the computer system 100. The user interface screen can also be used to manage the information technology components by performing operations on the units of management 14 using the context sensitive menu 18 corresponding to the unit of management. Various operations can be performed on the units of management 14, and the operations generally can be categorized into deployable, diagnosable, dynamic automation, documentable, delegatable, and disaster-recoverable operations. Deployable is the ability of the unit of management 14 to be moved to another location. For example, in a database system, the database moving to another server defines ‘deployable’ for the database unit of management 14. Diagnosable represents the ability to view and troubleshoot issues that the unit of management 14 might raise. Dynamic is the ability to configure multiple units of management 14 using policies, rules, scripts, etc. Documentable is the ability to document the configuration, dependencies and changes to the configuration and dependencies of the unit of management 14. Delegatable relates to the security aspects of the unit of management 14. This can include who can do what (authorization) as well as the identity of the unit of management 14. Disaster-recoverable relates to operations to backup, and restore from backups, a unit of management 14. These categories do not represent definitive types of operations that can be performed on a unit of management 14. Other operations may be performed on the unit of management 14. For example, for managing intangible units of management 14 like service levels, an operation could be to discover objects that impact a particular service level.

Other operations that can be performed are copy, paste, cut, move, delete, select, multiple select, undo, redo, resize and other typical operations in a user interface to manage objects.

A process is a set of operations on one or more units of management 14. The set of operations on the units of management 14 can be sequenced. Conditional branching and looping and other procedural constructs can be utilized to define the sequence. A Process explorer can be used to create new processes and modify existing processes. Processes can be executed immediately or scheduled to be performed at a later point of time. Processes reference units of management 14 in the grid 10 as to where the actual operations are performed.

When a user launches the software application, the application initially searches for and discovers the information technology components associated with the computer system 100. The user can then start with an empty grid 10. Users can select one or more units of management 14 from the unit of management explorer 20, drag and drop the selected units of management 14 into respective cells 12 in the grid 10. The user can then link different units of management 14, and label them.

Once one or more units of management 14 are added to the grid 10, related units of management 14 can be dynamically added. For example, if a server unit of management 14 has been added, clicking on an expand icon in that cell 12 could dynamically add all the applications (as units of management 14) available in that server. Subsequently, the units of management 14 can be collapsed by clicking on the collapse icon.

When performing operations to manage the information technology components, users can conduct group cell operations by choosing multiple cells 12 and performing operations across the entire group of units of management 14.

A set of operations on different units of management 14 can be sequenced with conditional logic. A separate process automation window can show the process, referencing units of management 14 from the grid 10. Alternatively, the operations in the grid 10 can be automated using a scripting language and an object model that is provided with the grid 10, without any user interface.

Referencing units of management 14 can be done using the cell 12 and row numbers. This reference can be used in policies, rules, automation scripts and other User Interface windows to locate the units of management 14 and perform operations.

The grid 10 can be shared by many users. This forms a central model for managing different units of management 14 in the live environment. Each cell 12 has operations that can be delegated as to who can do what with that unit of management 14. For example, a database administrator can perform all operations on a database server; however a network administrator can only view that database server's configurations.

When change needs to be made to a unit of management 14, the change process can require approval by a different user. So a change initiator initiates the change, and an approver would approve the change.

Multiple views of the same set of units of management 14 can be used by administrators depending on their individual needs. As an example, operations personnel can maintain a ‘health view’, engineering personnel can maintain and ‘architectural view’, whereas senior management can maintain a ‘global management view’. Views can share units of management information amongst each other based on rules.

The grid 10 can be used to model and simulate changes before they occur in the environment. Configuration changes and dependency changes can be modeled and simulated in the grid 10, before actually implementing the change in the live environment. Process Automation can be used to realize the modeled changes in the live environment.

Importing and exporting information in the grid 10, unit of management explorer 20 and Process explorer from other formats such as XML files, Excel sheets, text files and other document formats is supported.

The grid 10 can be persisted in a file on a computer, or in a database. A saved grid 10 can be later opened and manipulated.

The grid 10 can integrate with other systems to launch specific functions. Conversely, deployment solutions, monitoring solutions, disaster-recovery solutions and other solutions can integrate with the grid 10 to perform operations on the unit of management 14 in the grid 10.

The grid 10 can be printed. Reports about information contained in the grid 10, units of management explorer 20 and Process explorer can be formulated and made available as well.

The grid 10 and all unit of management features can be implemented as a rich client Windows application. The data in the grid 10 can be stored in a file or a central database. The software application can also run in a Terminal Services environment, where the application runs on session in a central server. Different users connect to the terminal server to interact with the application.

The grid 10 and all units of management features can be implemented as a Web based application. The users launch a web browser such as Internet explorer or Firefox and interact with the application. In this case, the application runs on the web server.

The grid 10 and all units of management features can be implemented as applications in a mobile device such as smart phones, PDA's and other such hand held devices. In this instance, the application runs on the mobile device.

The grid 10 and all units of management features can be run as a Smart Client application. The users use a browser, which caches a copy of the application on the user's computer. The user then interacts with the application that runs on the user's computer.

When an operation is performed on a unit of management 14 and the operation requires modification to the underlying application, the system may use an agent located either on the actual system or remotely from another server to perform the actual operation.

While specific embodiments of the present invention have been described, it should be noted that various modifications thereto can be made without departing from the spirit and scope of the invention as defined in the appended claims.

What is claimed is:

1. A computer system associated with one or more information technology components, said computer system comprising:
a display;
means for causing a grid having a plurality of cells to be shown on said display, wherein each cell is capable of containing a unit of management; and
means for adding units of management to said grid, wherein each unit of management is contained in a corresponding cell.

2. The computer system of claim 1 further comprising means for causing information about a unit of management to be displayed.

3. The computer system of 2 wherein said information is selected from the group consisting of a name for said unit of management, an icon representing the type of said unit of management, an icon representing the health status of said unit of management, performance graphs, metrics associated with said unit of management, selected configuration settings of said unit of management, and status of automated operations for said unit of management.

4. The computer system of claim 1 wherein said cells are hexagonal.

5. The computer system of claim 1 further comprising means for causing a link between two units of management to be shown on said display to indicate a relationship between said two units of management.

6. The computer system of claim 1 further comprising:
means for discovering information technology components associated with said computer system; and
means for causing said discovered components to be shown on said display as a list of units of management.

7. The computer system of claim 6 wherein said means for adding units of management to said grid includes means for permitting a user to drag and drop a unit of management from said list of units of management into a cell.

8. The computer system of claim 1 further comprising means for managing one or more aspects of a unit of management.

9. A method of using a computer system to visualize and manage information technology components associated with said computer system, said method comprising:
displaying a grid having a plurality of cells, wherein each cell is capable of containing a unit of management;
receiving user input associating a first unit of management with a first one of said cells; and
displaying said first unit of management in said first cell in response to said user input.

10. The method of claim 9 wherein displaying said first unit of management in said first cell includes displaying information about said first unit of management.

11. The method of 10 wherein said information is selected from the group consisting of a name for said first unit of management, an icon representing the type of said first unit of management, an icon representing the health status of said first unit of management, performance graphs, metrics associated with said first unit of management, selected configuration settings of said first unit of management, and status of automated operations for said first unit of management.

12. The method of claim 9 wherein said cells are hexagonal.

13. The method of claim 9 further comprising:
receiving additional user input associating a second unit of management with a second one of said cells; and
displaying said second unit of management in said second cell in response to said additional user input.

14. The method of claim 9 further comprising displaying a link between said first unit of management and said second unit of management in response to user input indicating a relationship between said first unit of management and said second unit of management.

15. The method of claim 9 further comprising:
discovering information technology components associated with said computer system; and
displaying said discovered components as a list of units of management.

16. The method of claim 15 wherein receiving user input associating a first unit of management with a first one of said cells includes permitting a user to drag and drop said first unit of management from said list of units of management into said first cell.

17. The method of claim 9 further comprising allowing a user to manage one or more aspects of said first unit of management via said grid.

18. A computer readable medium containing instructions for controlling a computer system to visualize and manage information technology components associated with said computer system, wherein said method comprises:
displaying a grid having a plurality of cells, wherein each cell is capable of containing a unit of management;
receiving user input associating a first unit of management with a first one of said cells; and
displaying said first unit of management in said first cell in response to said user input.

19. The computer readable medium of claim 18 wherein displaying said first unit of management in said first cell includes displaying information about said first unit of management.

20. The computer readable medium of 19 wherein said information is selected from the group consisting of a name for said first unit of management, an icon representing the type of said first unit of management, an icon representing the health status of said first unit of management, performance graphs, metrics associated with said first unit of management, selected configuration settings of said first unit of management, and status of automated operations for said first unit of management.

21. The computer readable medium of claim 18 wherein said cells are hexagonal.

22. The computer readable medium of claim 18 wherein said method further comprises:
receiving additional user input associating a second unit of management with a second one of said cells; and
displaying said second unit of management in said second cell in response to said additional user input.

23. The computer readable medium of claim 22 wherein said method further comprises displaying a link between said first unit of management and said second unit of management in response to user input indicating a relationship between said first unit of management and said second unit of management.

24. The computer readable medium of claim 18 wherein said method further comprises:
discovering information technology components associated with said computer system; and
displaying said discovered components as a list of units of management.

25. The computer readable medium of claim 24 wherein receiving user input associating a first unit of management with a first one of said cells includes permitting a user to drag and drop said first unit of management from said list of units of management into said first cell.

26. The computer readable medium of claim 18 wherein said method further comprises allowing a user to manage one or more aspects of said first unit of management via said grid.
